(19) United States
(12) Patent Application Publication
(10) Pub. No.: US 2015/0308642 A1
(43) Pub. Date: Oct. 29, 2015

(54) Self-Aiming Track Light Fixture System and Method

(71) Applicant: General LED, Inc., San Antonio, TX (US)

(72) Inventors: Vung Van Vo, San Antonio, TX (US); Michelle Kum Huang, San Antonio, TX (US)

(73) Assignee: GENERAL LED, INC., San Antonio, TX (US)

(21) Appl. No.: 14/694,304

(22) Filed: Apr. 23, 2015

Related U.S. Application Data
(60) Provisional application No. 61/983,130, filed on Apr. 23, 2014.

(51) Int. Cl. F21S 8/04; H04N 5/225; H04N 5/232; F21V 33/00; F21V 14/02

(52) U.S. Cl. CPC F21S 8/046; F21V 33/0052; F21V 14/02; H04N 5/23229; H04N 5/2256; H04N 5/23222; F21W 2131/40

(57) ABSTRACT

A camera, a mechanical movement system and a video control board are used to locate a recognizable light source on a stationary or moving object to be illuminated. Once the recognizable light source is recognized by the camera, the video control board provides instructions to the mechanical movement system to move the light output from the source of illumination in a track light fixture assembly to the location of the recognizable light source.

### CROSS REFERENCE TO RELATED APPLICATON

This Non-Provisional U.S. Patent Application claims the benefit of Provisional U.S. Patent Application No. 61/983,130 filed Apr. 23, 2014.

### FIELD

The disclosed system and method pertains to track lighting systems; more particularly, the disclosed system and method pertains to a system and method for automatically aiming a track light at a stationary or moving object.

### BACKGROUND

A track light system is a combination of an electrically powered track and a light or source of illumination contained in a track light fixture assembly. The track portion of the track light system is typically mounted on a ceiling. The electrically powered track provides a mechanical attachment for positioning and supporting one or more track light fixture assemblies. In addition, the electrically powered track provides the needed electrical energy to cause the sources of illumination in the track light fixture assemblies to have a light output.

Each track light fixture is initially positionable along the length of the electrically powered track by mechanically securing the track light fixture assembly to the electrically powered track using a connector. The connector typically engages the electrically powered track with a quarter turn. The initial positioning of a selected track light fixture assembly along the electrically powered track is determined by the location of an object such as a painting, a piece of sculpture, a mannequin, or a featured product.

When a track light fixture assembly is used in a retail setting to illuminate a mannequin or a featured product, the track light fixture assembly must be properly positioned or aimed at the mannequin or featured product. Such aiming includes moving the track light fixture assembly from side to side about a substantially vertical or pan axis, and moving the track light fixture up and down about a substantially horizontal or tilt axis.

Prior art track light fixture assemblies are typically moved by a workman. The workman climbs a ladder and physically manipulates the track light fixture assembly to assure that the light emitted by the source of illumination is pointed at the mannequin or featured product.

Oftentimes the aiming process requires that a second person be located near the mannequin or featured product to instruct the workman on the ladder how to manually adjust the track light fixture assembly so that the emitted light is on the correct spot. If the workman is working alone, numerous trips up and down the ladder may be required until the position of the track light fixture assembly is correct.

While there have been numerous attempts to create a remote control movement system for track light fixture assemblies, such as described in U.S. Pat. No. 6,655,817 to Devlin et al., no remote control movement system has become generally accepted among manufacturers of track light systems. Further, the accuracy for positioning a track light fixture assembly to emit light for proper illumination of a desired object is only as good as the ability of the operator of the remote control to assure that the emitted light from the track light fixture assembly is at the proper place on the object to be illuminated.

Accordingly, there remains a need in the art for a system and method which automatically enables aiming a selected track light fixture assembly of a track light system so that the position of the light output from source of illumination in the track light fixture assembly on the object to be illuminated can be properly and continuously located on the object to be illuminated.

### SUMMARY

The system and method of the present invention automatically enables aiming a selected track light fixture assembly portion of a track light system so that the position of the light output from the source of illumination in the track light fixture assembly can be properly and continuously located on the object to be illuminated.

According to the disclosed system and method, a camera, a mechanical movement system and a video control board are contained in a first module. The images received by the camera are transformed by the video control board into instructions to the mechanical movement system. The mechanical movement system enables movement of the source of illumination about a pan axis and a tilt axis.

A battery powered, handheld controller held by an operator is used to activate the video control board and to provide a light source recognizable by the camera. Once the object is properly illuminated by the light output from the source of illumination, a light signal is produced indicating that the aiming process has been completed.

In a discontinuous mode, the video control board is either manually or automatically de-activated when the light output of the source of illumination has been positioned on the location of the light source recognizably by the camera.

In a continuous mode, the video control board remains active after the light output from the source of illumination has been positioned on the location of the light source recognizable by the camera. The camera will continue to track the movement of the light source recognizably by the camera and will cause the mechanical movement system to move the source of illumination so that its light output remains on the light source recognizable by the camera even while the light source recognizable by the camera is in motion.

### BRIEF DESCRIPTION OF THE DRAWING FIGURES

A better understanding of the disclosed self-aiming track light fixture system and method may be had by reference to the drawing figures wherein:

FIG. 1 is a perspective view of a track light fixture assembly including the self-aiming system of the present invention;

FIG. 1A is a side elevational view of the track light fixture assembly shown in FIG. 1 with a portion broken away to show the parallelism of the camera axis “C” and the axis “M” of the of the module containing the light source;

FIG. 2 is a perspective view of a track light fixture assembly similar to FIG. 1 but showing the camera and the mechanical movement system;

FIG. 3A is a schematic view depicting the disclosed track light system at the beginning of the self-aiming process;

FIG. 3B is a schematic view depicting the disclosed track light system at the end of the self-aiming process;

FIG. 4 is a block diagram illustrating the inputs, outputs and operation of the video control board; and

FIG. 5A and FIG. 5B are perspective views of a first and second embodiment of an exemplary handheld controller.

### DESCRIPTION OF THE EMBODIMENTS

A still better understanding of the disclosed self-aiming track light fixture system and method 10 may be had by an understanding of its construction and operation.

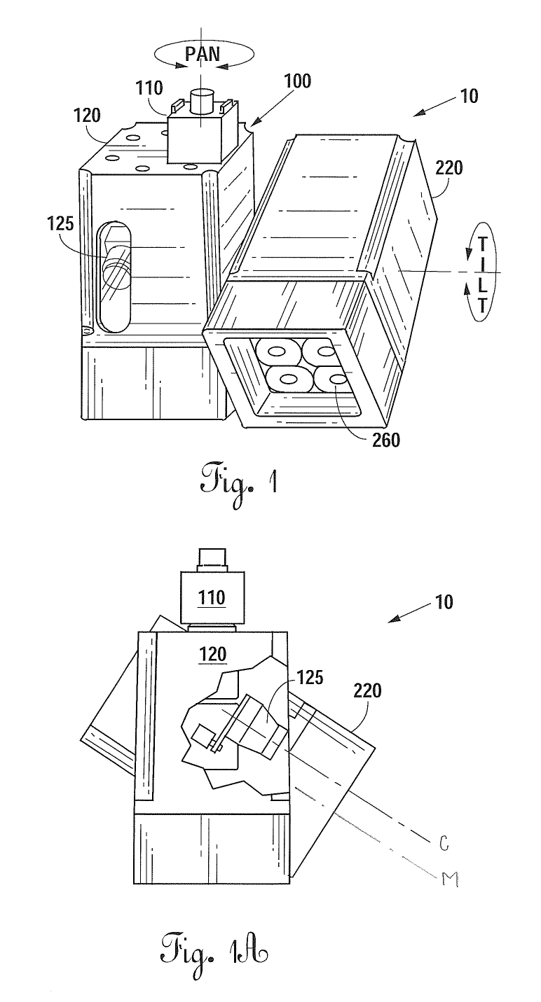

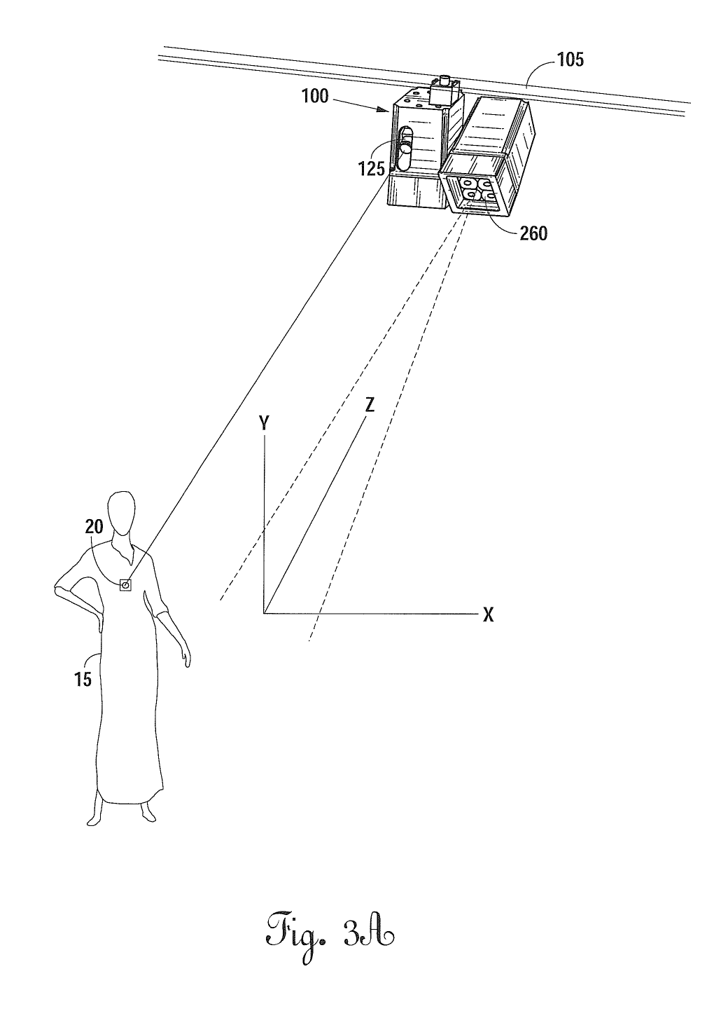

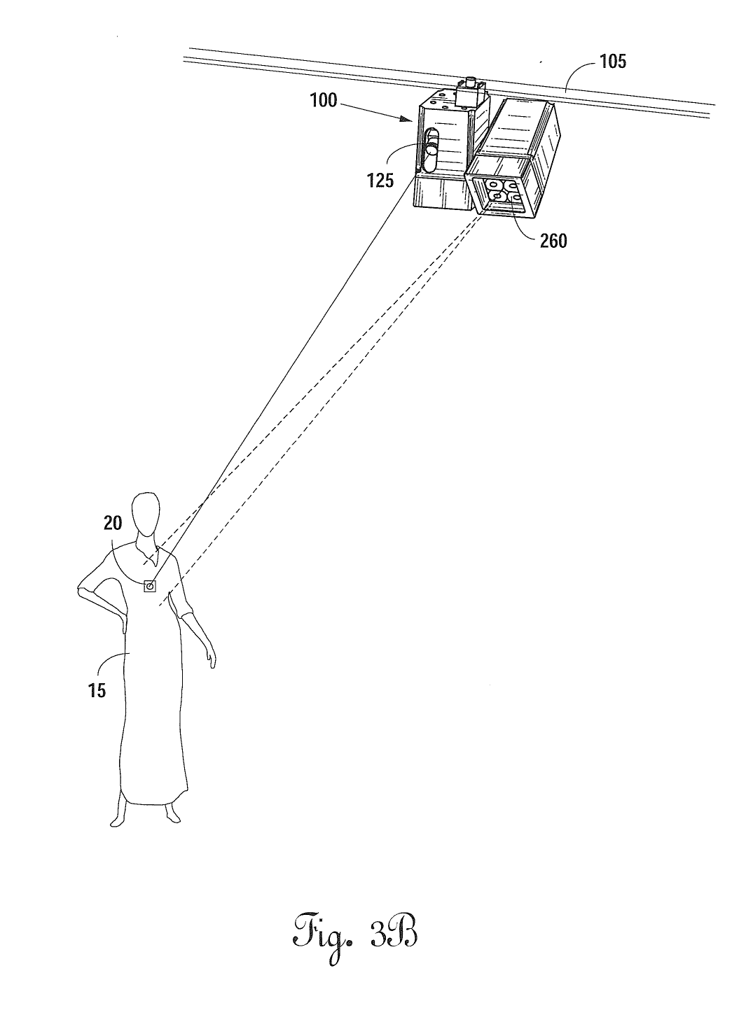

Shown in FIG. 1 is a track light fixture assembly 100. As well understood by those of ordinary skill in the art, the track light fixture assembly 100 is mechanically and electrically connected to an electrically powered track 105 (FIG. 3A). The electrically powered track 105 is typically mounted on a ceiling; however, the electrically powered track 105 may also be mounted on a wall or floor surface. At the top of the track light fixture assembly 100 is a connector 110 which mechanically and electrically engages the electrically powered track 105. The position of the track light fixture assembly 100 on the electrically powered track is selected by the installer. Typically, three or four track light fixture assemblies 100 are connected to a single section of electrically powered track 105. Each track light fixture assembly 100, including the disclosed system and method 10, is then individually aimed.

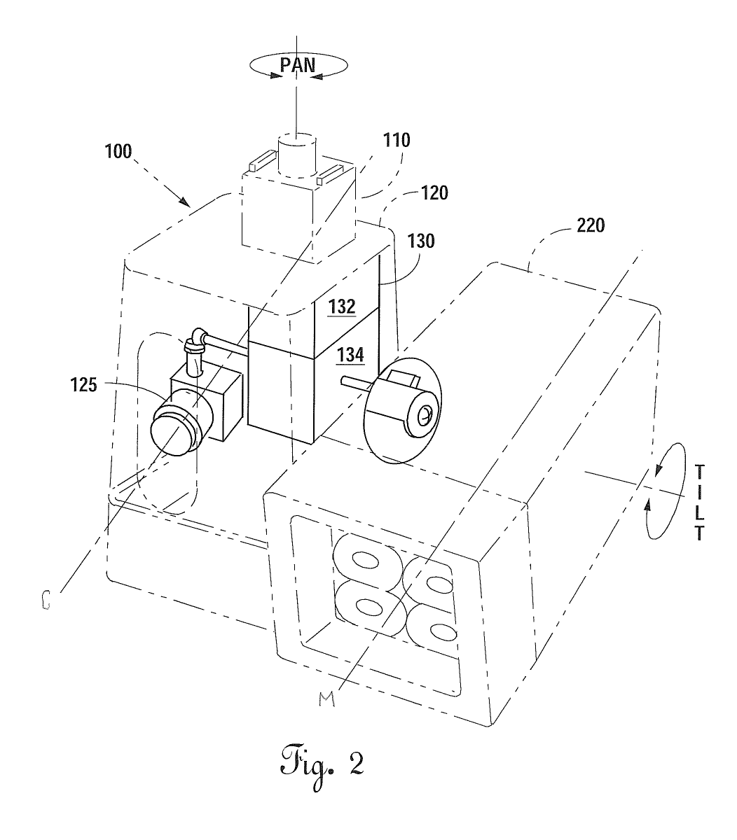

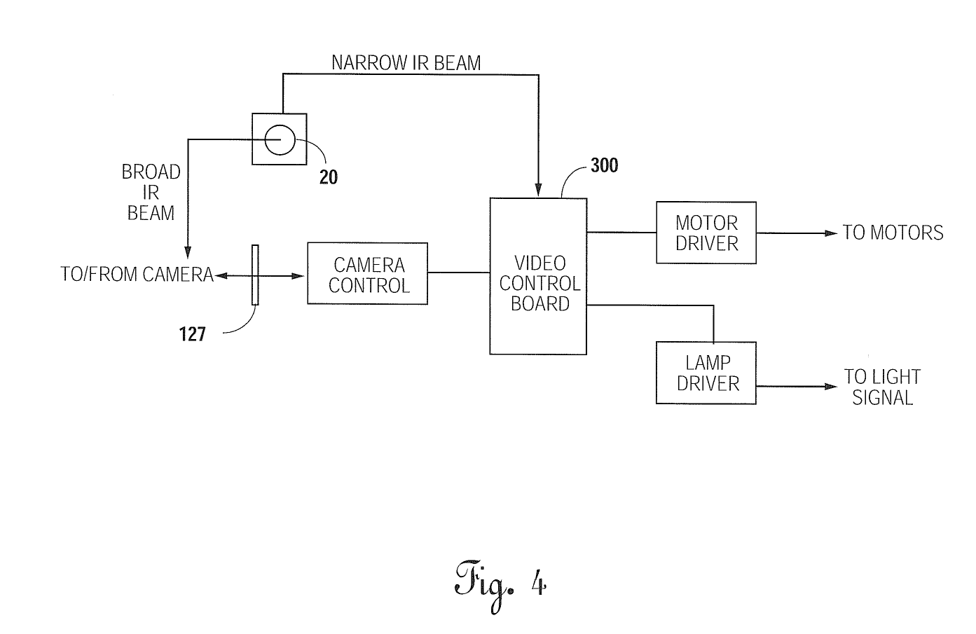

As shown in FIG. 2, beneath the connector 110 is a first module 120 which contains a camera 125, a mechanical movement system 130, and a video control board 300 (FIG. 4). Adjacent to the first module 120 is a second module 220 which contains a source of illumination 260. As may be seen in FIG. 1A, the long axis “M” of the light output of the source of illumination 260 in the second module 220 is substantially parallel to the axis “C” of the camera 125. Thus, the source of illumination 260 and the camera 125 move together about a substantially horizontal TILT axis as shown in FIG. 1.

The entire track light fixture assembly 100 also moves about a substantially vertical PAN axis, as shown in FIG. 1, which substantially vertical PAN axis passes through the connector 110. Thus, by movement of the track light fixture assembly 100 about both the substantially horizontal TILT axis, and the substantially vertical PAN axis, the light output from the source of illumination 260 may be placed on a target.

The advantage of the disclosed system and method is that placing the light output from the source of illumination 260 on a target may be done automatically without having to manually or remotely adjust the position of the track light fixture assembly 100 with respect to the electrically powered track 105.

The construction of the mechanical movement system 130 contained within the first module 120 may be shown by reference to FIG. 2. Therein, the connector 110 is shown connected to a PAN axis motor 132 having a substantially vertical shaft. Rotation of the substantially vertical shaft of the PAN axis motor 132 moves the entire track light fixture assembly 100 from side to side, thereby moving the light output of the source of illumination 260 from side to side.

Beneath the PAN axis motor 132 is a TILT axis motor 134. Rotation of the substantially horizontal shaft of the TILT axis motor moves the second module 220 up and down, thereby moving the light output of the source of illumination 260 up and down. As described above, the camera 125 and the source of illumination 260 in the second module 220 move together.

In an alternate embodiment, only one motor in the first module 120 may be used for moving the second module 220 about the substantially horizontal TILT axis. A single PAN axis motor may be associated with all of the track light fixture assemblies mounted to the electrically powered track 105 for turning all of the track light fixture assemblies attached to the electrically powered track 105 all together from side to side at one time.

A description of the operation and assembly of the motors which may be used in the mechanical movement system 130 appears in Published U.S. Patent Application No. 2013/0155672 which is incorporated herein by reference. Therein each motor is associated with a drive system which enables the movement of the source of illumination.

Also described in Published U.S. Patent Application No. 2013/0155672 is the use of a single motor. When a single motor is used, the single motor may be electronically connected to a clutch. In one mode, the clutch connects the motor to a drive system which enables movement of the source of illumination from side to side about a substantially vertical axis. In a second mode, the clutch connects the motor to a drive system which enables movement of the source of illumination up and down about a substantially horizontal axis.

In the preferred embodiment of the disclosed system and method, two gearless stepper motors 132 and 134 are used in the mechanical movement system 130.

The movement of the source of illumination 260 in the second module 220 is best understood by superimposing an x-axis or horizontal axis, and a y-axis or vertical axis on the output of light from the source of illumination, as shown in FIG. 3A. The PAN axis motor 132 moves the source of illumination along the x-axis, and the tilt axis motor 134 moves the source of illumination along the y-axis. In another embodiment, a third motor may be used to move the source of illumination 260 within the second module 220 along the z-axis if there is a need for focusing or shaping the light pattern of emitted light from the source of illumination 260.

FIG. 3A and FIG. 3B are schematic diagrams which illustrate the beginning and ending of the operation of the disclosed self-aiming track light system and method 10. Therein it may be seen that an IR beam emitter 20 is placed on a mannequin 15. The IR beam emitter 20 emits a broad beam of light (˜180 degrees). The image perceived by the camera 125 in FIG. 3A and the image interpretation software on the video control board 300 (see FIG. 4) in the first module 120 detects the location of the point of emission of the broad beam of IR light. Once located, the video control board 300 actuates the mechanical movement system 130 which causes the PAN motor 132 and the TILT motor 134 to move the source of illumination 260 so that the light output at the origin of the x-y-z coordinate system shown in FIG. 3A is moved to the location of the point of emission 20 of the broad beam of IR light, as shown in FIG. 3B.

Shown in FIG. 4 is a block diagram further illustrating the operation of the disclosed system and method. The camera 125 or CCD image sensor is best understood as being a video camera which receives color images. The camera 125 sees the area where the target, as shown in FIG. 3 as mannequin 15, is located. The video control board 300 includes a time clock which enables the camera 125 to take pictures at a predetermined frequency as the PAN motor 132 and the TILT motor 134 are moving to track the relationship between the position of light from the broad beam of IR light from the emitter 20 and the light output from the source of illumination 260. If desired, the camera 125 may include a self-focusing feature to better determine the location of the point of emission of the broad beam of IR light.

The images perceived by the camera 125 pass through a narrow band pass filter 127. The narrow band pass filter 127 is designed and selected to allow the passage of only certain frequencies of light while rejecting all other frequencies of light. Specifically, only a small range of light frequencies which include the spectral wavelength from the emitter 20 of the broad beam of IR light pass through the narrow band pass filter 127. Once a portion of the broad beam of IR light passes through the narrow band pass filter 127, the image perceived by the camera 125 is a low definition, gray scale monochromatic image.

The image perceived by the camera 125 is conveyed to the video control board 300. Therein software on the video control board 300 continuously processes the low definition, gray scale monochromatic image to remove everything but the appearance of a white spot on a black background. The white spot on the black background is the location of the point of emission of the broad beam of IR light coming from the emitter 20 on the mannequin 15.

As the video control board 300 knows the position of the light output from the source of illumination 260 and the track light assembly fixture 100, it is now able to calculate the distance between the location of the emitter 20 and the position of the light output. This distance is broken into a component along the x-axis and a component along the y-axis. Using these distances, the video control board 300 provides a signal to the PAN motor 132 and the TILT motor 134 which determines the amount of movement or the number of steps by the stepper motors 132, 134 needed for the light output from the source of illumination 260 to move to the location of the point of emission of the broad beam of IR light.

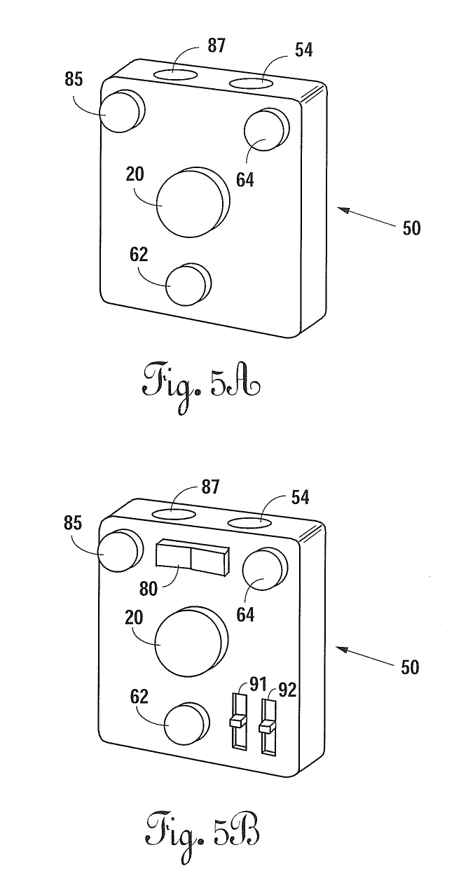

A still better understanding of the self-aiming track light system and method 10 may be had from an understanding of how an operator might use the invention in a retail setting where the emitted light from a source of illumination 260 is to be placed on a mannequin 15 such as shown in FIGS. 3A and 3B. The operator uses a battery-powered handheld device 50 such as shown in FIG. 5A or FIG. 5B to communicate with the video control board 300. A switch button 87 is used to turn on the battery-powered handheld device 50. The process begins with the operator selecting the track light fixture assembly 100 or assemblies which will be used to put light on the mannequin 15. The operator presses button 64 to cause the narrow IR beam to be emitted from emitter 54. The receipt of the narrow IR beam by a receptor (not shown) in the first module 120 turns on the video control board 300 in the track light fixture assembly 100 selected by the operator.

The operator then places the handheld device 50 on the mannequin or featured product and pushes button 62. Button 62 turns on the emitter 20 of the broad IR light beam.

As the video control board 300 was turned on by receipt of the narrow IR beam by an IR receptor in module 120, the camera 125 will be moved by the mechanical movement system 130 until the camera 125 is pointed at the emitter 20. This movement of the camera 125 and the light output from the source of illumination 260 is accomplished by the use of the signals sent by the video control board 300 to the PAN motor 132 and the TILT motor 134.

Once the light output of the source of illumination 260 has been co-located with the position of the emitter 20 of the broad beam of IR light, the video control board 300 sends a signal, such as a flashing of the light output from the source of illumination 260 in the second module 220, to indicate that the aiming process has been completed.

In the discontinuous mode of operation, the operator may use the handheld device 50 to de-activate the video control board 300 by pushing button 64 to emit a narrow IR beam from the emitter 54 on the handheld controller 50. Alternatively, the video control board 300 may be de-activated automatically after the light output from the source of illumination 260 has flashed for a predetermined period of time; for example, 30 seconds. In another automatic de-activation, a light sensor 80 on the handheld controller 50, as shown in FIG. 3B, may be used to detect the flashing of the light output from the source of illumination 260 and de-activate the video control board 300 when the flashing is sensed.

If the operator decides to make a small movement in the position of a certain mannequin or if a mannequin is moved for cleaning or maintenance, the self-aiming track light fixture system and method 10 is used, as described above, to reposition the light output from the source of illumination 260.

In the continuous mode of operation, the video control board 300 is not de-activated when the light output from the source of illumination 260 has been co-located with the position of the emitter 20 of the broad beam of IR light. This means that if the mannequin 15 is a human being that moves along a path such as a runway, the camera 125 will detect the movement. The video control board 300 will then continuously move the mechanical movement system 130 to cause the light output from the source of illumination 260 to stay with the broad IR light beam from the emitter 20. Those of ordinary skill in the art will understand that in the continuous mode of operation, it may be necessary to place the emitter 54 at a higher location so that the wide IR beam will be continuously within the are viewable by the lens of the camera 125.

In the discontinuous mode of operation where the video control board 300 is deactivated, either by the operator, the passage of a fixed period of time or the receipt of a light signal by the handheld controller 50, the position of the source of illumination 260 in the track light fixture assembly 100 is fixed.

If desired, the handheld controller 50 may include additional functionalities such as a button 85 enabling the operator to turn off the source of illumination 260 or on without changing the position of the source of illumination 260. Additionally, the handheld controller 50 may also include a slide control 91 where a rheostat may be used to alter the light output of the track light fixture assembly 100. If desired, the handheld controller 50 may also include a control 92 to focus the light output from the source of illumination 260.

While the disclosed self-aiming track light system and method has been disclosed according to preferred and alternate embodiments, those of ordinary skill in the art will understand that still other embodiments have been enabled according the foregoing disclosure. Such other embodiments shall fall within the scope and meaning of the appended claims.

What is claimed is:

1. A self-aiming track light fixture system including an electrically powered track and a track light fixture assembly mechanically and electrically connected thereto, said self-aiming track light fixture system comprising:
a first module containing a camera, a mechanical movement system and a video control board, said video control board providing instructions to said mechanical movement system based on the use of images received by said camera and processed by said video control board;
a second module containing a source of illumination providing a light output, said second module being movable by said mechanical movement system in said first module;
a handheld controller, said handheld controlled controller enabling:
activation of said video control board;
provision of a light source recognizable by said camera;
wherein, when said camera recognizes said light source emanating from said handheld controller, said video control board will provide instructions to said mechanical movement system to move the light output from said source of illumination to the location of said light source recognizable by said camera.

2. The self-aiming track light fixture system as defined in claim 1 wherein said mechanical movement system includes a pan axis stepper motor and a tilt axis stepper motor.

3. The self-aiming track light fixture system as defined in claim 2 wherein said video control board provides said pan axis stepper motor and said tilt axis stepper motor with the number of steps to be taken to move the light output of said source of illumination to the location of said light source recognizable by said camera.

4. The self-aiming track light fixture system as defined in claim 1 wherein said camera includes a filter which transforms the image perceived by said camera into a monochrome image.

5. The self-aiming track light fixture system as defined in claim 4 wherein said video control board includes a software filter which locates the area of highest light intensity in said monochrome image.

6. The self-aiming track light fixture system as defined in claim 5 wherein said camera may adjust the focus of the area of highest light intensity in said monochrome image.

7. The self-aiming track light fixture system as defined in claim 1 wherein said video control board causes a light signal to be emitted from said track light fixture assembly when the output of said source of illumination has been positioned on the location of said light source recognizable by said camera.

8. The self-aiming light fixture system as defined in claim 7 wherein when said light signal from said track light fixture assembly has been detected by said handheld controller and causes a signal to be emitted from said handheld controller which deactivates said video control board.

9. The self-aiming light fixture system as defined in claim 1 wherein said camera is located within said source of illumination.

10. The self-aiming light fixture system as defined in claim 1 wherein said handheld controller may be used to adjust at least one of the following functionalities after the light output from said source of illumination has been positioned on the location of said light source recognizable by said camera, said functionalities including:
a) turning the source of illumination off;
b) adjusting the light output of the source of illumination, and
c) focusing the light output of the source of illumination.

11. A method for enabling the self-aiming of a track light fixture system including an electrically powered track and a track light fixture mechanically and electrically connected thereto, said method for enabling the self-aiming of a track light fixture comprising:
placing a camera, a mechanical movement system and a video control board in a first module, said video control board providing instructions to said mechanical movement system based on images perceived by said camera;
placing a source of illumination providing a light output in a second module, said second module be movable by said mechanical movement system in said first module;
providing an operator with a handheld controller, said handheld controller enabling:
activation of said video control board;
provision of a light source recognizable by said camera;
wherein when said camera recognizes said light source emanating from said handheld controller, said video control board will provide instructions to said mechanical movement system to move the light output of said source of illumination to the location of said light source recognizable by said camera.

12. The method for enabling the self-aiming of a track light fixture system as defined in claim 11 wherein said mechanical movement system includes a pan axis stepper motor and a tilt axis stepper motor.

13. The method for enabling the self-aiming of a track light fixture system as defined in claim 12 wherein said video control board provides said pan axis stepper motor and said tilt axis stepper motor with the number of steps to be taken to move the light output of said source of illumination to the location of said light source recognizable by said camera.

14. The method for enabling the self-aiming of a track light fixture system as defined in claim 11 wherein said camera includes a filter which transforms the image perceived by said camera into a monochrome image.

15. The method for enabling the self-aiming of a track light fixture system as defined in claim 14 wherein said video control board includes a software filter which locates the area of highest light intensity in said monochrome image.

16. The method for enabling the self-aiming of a track light fixture system as defined in claim 15 wherein said camera may adjust the focus of the area of highest light intensity in said monochrome image.

17. The method for enabling the self-aiming of a track light fixture system as defined in claim 11 wherein said video control board causes a light signal to be emitted from said track light fixture assembly when the output of said source of illumination has been positioned on the location of said light source recognizable by said camera.

18. The method for enabling the self-aiming of a track light fixture system as defined in claim 17 wherein said light signal from said track light fixture assembly has been detected by said handheld controller and causes a signal to be emitted from said handheld controller which deactivates said video control board.

19. The method for enabling the self-aiming of a track light fixture system as defined in claim 11 wherein said camera is located within said source of illumination.

20. The method for enabling the self-aiming of a track light fixture system as defined in claim 11 wherein said handheld controller may be used to adjust at least one of the following functionalities of the light output from said source of illumination has been positioned on the location of the light source recognizable by said camera, said functionalities including:
a) turning the source of illumination off;
b) adjusting the light output from the source of illumination, and
c) focusing the light output of the source of illumination.
